(19) United States
(12) Patent Application Publication
(10) Pub. No.: US 2005/0083650 A1
(43) Pub. Date: Apr. 21, 2005

(54) Auxiliary cooling device for a notebook computer

(76) Inventor: Hsin-Fa Yang, Pingjhen City (TW)

Correspondence Address: DENNISON, SCHULTZ & DOUGHERTY, 612 CRYSTAL SQUARE 4, 1745 JEFFERSON DAVIS HIGHWAY, ARLINGTON, VA, 22202, US

(21) Appl. No.: 10/689,050

(22) Filed: Oct. 21, 2003

(51) Int. Cl. G06F 1/20

(52) U.S. Cl. 361/687

(57) ABSTRACT

An auxiliary cooling device for a notebook computer, the device is for placing beneath the notebook computer and is comprised of: a base with a receiving space therein and at least a heat-sinking hole in communication with outside; at least a fan mounted in the base, and being communicated with outside via the heat-sinking hole; and an upper lid having an upper panel provided with an air-venting hole. When the notebook computer is placed on the upper lid, heat generated by operating the notebook computer is led into the receiving space of the base, and is dissipated by running the fan, thus temperature of the notebook computer is lowered to afford long-time operation of the notebook computer without generating higher temperature. The device is suitable to help heat sinking of notebook computers.

### BACKGROUND OF THE INVENTION

1. Field of the Invention

The present invention is related to an auxiliary cooling device for a notebook computer, and especially to an auxiliary cooling device for a notebook computer able to lower temperature of the notebook computer to maintain its norm working temperature, this can afford long-time operation of the notebook computer; the device is suitable to help heat sinking of a notebook computer.

2. Description of the Prior Art

Following prosperous progressing of electronic information, computers have been the necessities for modern people at home, outdoors or in offices. Desktop computers have been the main type of computers for people before and are still quite popular presently. However, desktop computers have been limited in use cause they cannot be carried with by the users. The use of notebook computers is therefore continuously increasing in the recent years, and they have been the necessary outfits for the people on the move. Further, the function of Audio-Video software is nearly complete, youth nowadays are fond of taking notebook computers as Audio-Video output equipment to enjoy films or play music by carrying with the notebook computers.

Volumes of notebook computers are moderate and are therefore convenient for carrying. However, the simplified volume and speeds of processing of the CPUs' provided therein becoming faster and faster, this is accompanied with a problem of high temperatures that are extremely easy to be induced and hard to be overcome. Especially when a notebook computer is used for a long time, temperature during operation of it keeps on rising, heat is completely impossible to be dissipated just by using a heat sink provided in the notebook computer itself. In this condition, a notebook computer is unable to keep on using for a long time like the way of a desktop computer. Thus, if the problem of high temperature generating is not solved effectively, a notebook computer that is forcedly to use for a long time will make a user feel uncomfortable because of the high temperature. In addition, the long time generating of the high temperature will seriously damage the internal electronic elements of the notebook computers.

In view of these, to solve the above stated flaws, a notebook computer can have the heat generated during operation fast dissipate by adding an auxiliary cooling device, this can maintain the normal working temperature of the notebook computer. The inventor thereby developed the present invention based on his experience of years and continuous study in the art.

### SUMMARY OF THE INVENTION

The primary objective of the present invention is to provide an auxiliary cooling device for a notebook computer, its purpose is to lead heat generated during operation the notebook computer to a receiving space in a base, and with at least a fan is provided to dissipate hot air to lower temperature of the notebook computer. Thereby the notebook computer can be used for a long time.

The secondary objective of the present invention is to provide an auxiliary cooling device for a notebook computer, it renders the base to incline from its rear end to its front end; when an upper lid is connected therewith, the notebook computer can be laid flat with a tilting angle for the convenience of operating.

In order to achieve the above stated objectives, the auxiliary cooling device for a notebook computer of the present invention is placed beneath the notebook computer. And the device comprises a base, at least a fan and an upper lid. The base is a box with an opening on the upper side thereof, and forms a receiving space therein; it has at least a heat-sinking hole in communication with outside. The above-mentioned at least a fan is mounted in the base; the air-drawing end of the fan is located in the receiving space of the base, while the air-dissipating end of the fan can be communicated with outside via the heat-sinking hole. The upper lid is used to cover the upper side of the base; an upper panel of the upper lid has an air-venting hole. Hence when the notebook computer is placed on the upper lid, heat generated by the notebook computer can be led into the receiving space of the base, and is dissipating by running the fan; this can lower temperature for the notebook computer in long-time operation.

The present invention will be apparent after reading the detailed description of the preferred embodiment thereof in reference to the accompanying drawings.

### BRIEF DESCRIPTION OF THE DRAWINGS

FIG. 1 is a perspective view showing the appearance of a first embodiment of the present invention;

FIG. 2 is an exploded perspective view showing the members in the first embodiment of the present invention;

FIG. 3 is a perspective view showing an embodiment of a different upper lid of the present invention;

FIG. 4 is a perspective view showing a different application in connecting fans with a power supply of the present invention;

FIG. 5 is a schematic perspective view showing use of the first embodiment of the present invention;

FIG. 6 is a sectional view taken from FIG. 5;

FIG. 7 is an exploded perspective view showing the members in a second embodiment of the present invention;

FIG. 8 is a perspective view showing the appearance of the fans assembled on the base of the present invention;

FIG. 9 is a perspective view showing application of different fans of the present invention.

### DETAILED DESCRIPTION OF THE PREFERRED EMBODIMENT

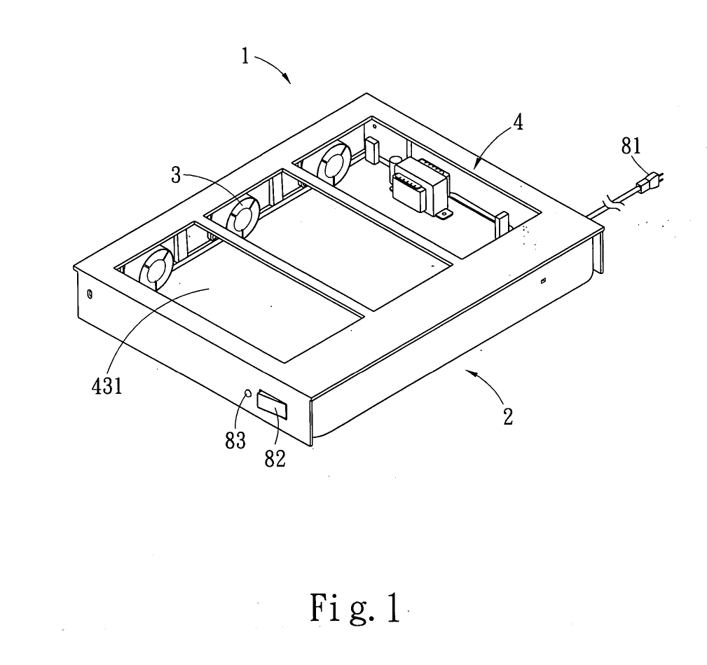

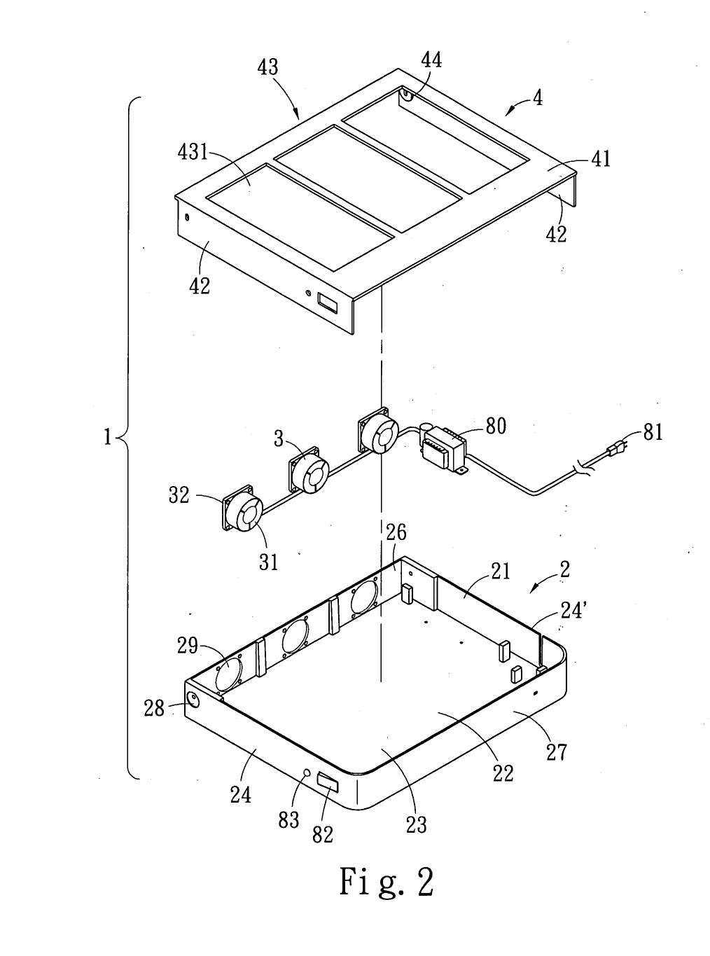

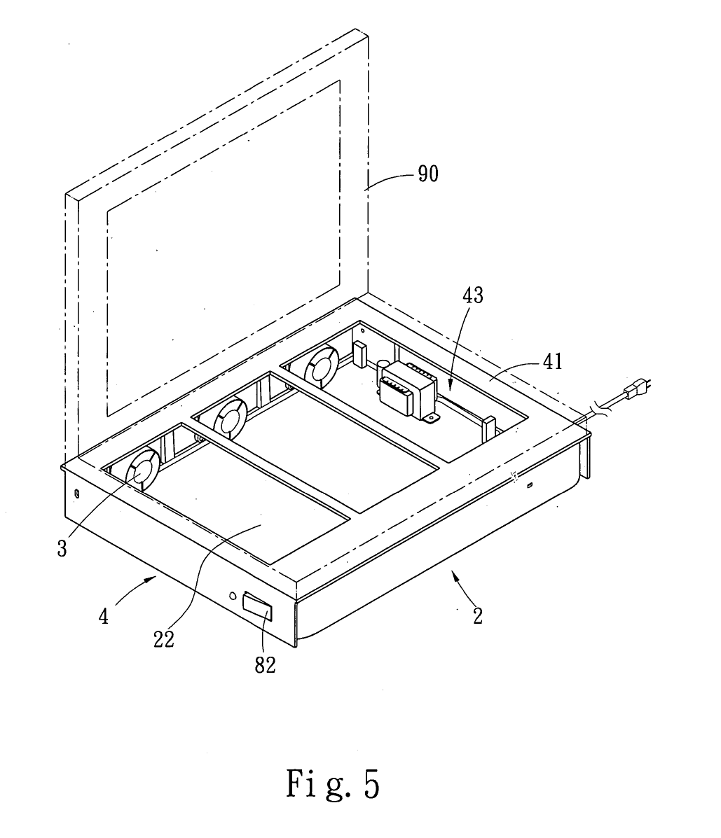

Referring to FIGS. 1 and 2 showing the first embodiment of an auxiliary cooling device for a notebook computer 90 of the present invention, the device is placed beneath the notebook computer 90 (as shown in FIG. 5), it comprises the primary members including a base 1, at least a fan 3 and an upper lid 4.

Wherein, the base 2 is an elongated box with an opening 21 on the upper side thereof, and forms a receiving space 22 therein; the box includes a bottom plate 23 and four upright peripheral side plates 24, 24′, 26, 27 extending upwardly from the bottom plate 23; the four upright peripheral side plates 24, 24′, 26, 27 of the base 2 can be of equal height, or can partially be inclined from one side to another side (to be described hereinafter). The two lateral side plates 24 and 24′ of the base 2 are provided on both the rear ends thereof with a round pivot hole 28; and the rear side plate 26 of the base 2 has at least one (there are three heat-sinking holes in this embodiment) round heat-sinking hole 29 in communication with outside.

The at least one (there are three fans in this embodiment) fan 3 is mounted in the base 2. The fan 3 is clung onto the heat-sinking hole 29 provided on the rear side plate 26 of the base 2, and is locked upright onto on the rear side plate 26, so that the air-drawing end 31 of the fan 3 is located in the receiving space 22 of the base 2, while an air-dissipating end 32 of the fan 3 can be communicated with outside the base 2 via the heat-sinking hole 29. The fan 3 further is connected with a transformer 80; when an electric plug 81 for connecting to a power supply is connected electrically, the state of running of the fan 3 is controlled by a power switch 82 and displayed by an indication lamp 83.

The upper lid 4 is used to cover the upper side of the base 2. The upper lid 4 is a plate and includes a panel 41 that is extended laterally and downwardly to form two side plates 42. The upper panel 41 of the upper lid 4 has an air-venting hole 43 including a plurality of rectangular holes 431. The two side plates 42 of the upper lid 4 are provided on both the rear ends thereof with a pivot connecting-axle 44 extending inwardly in the shape of a round plate, they can thereby be pivot connected with the round pivot holes 28 provided on the two lateral side-plates 24, 24′ of the base 2, so that the upper lid 4 is liftable.

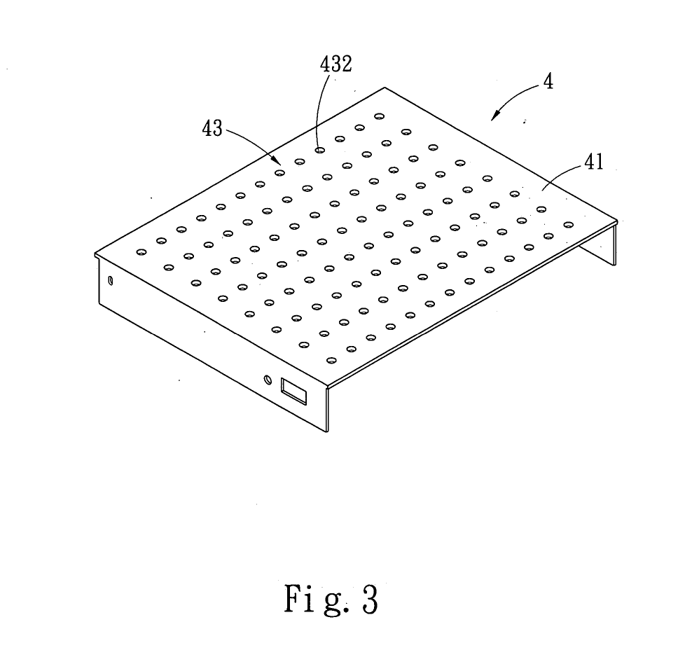

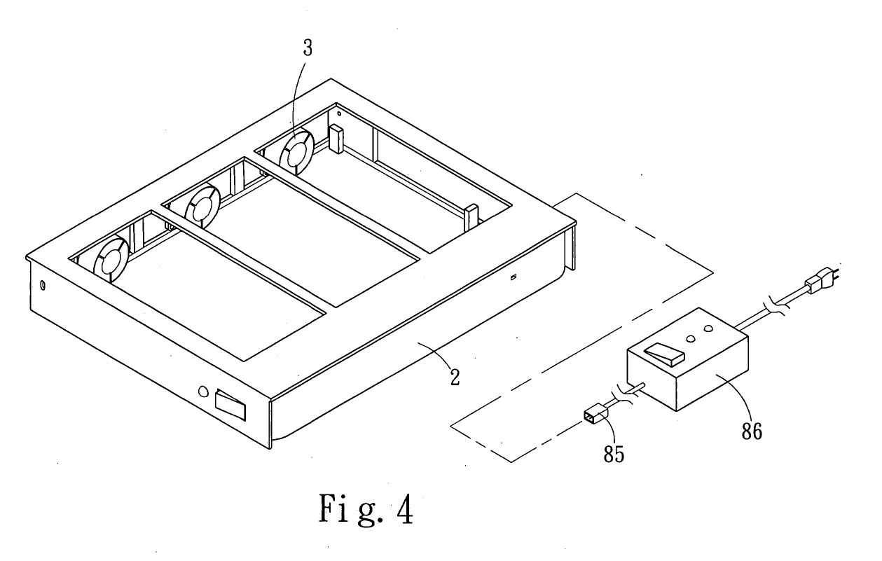

Referring to FIG. 3, the air-venting hole 43 on the upper panel 41 of the upper lid 4 can alternatively include a lot of holes 432 arranged in an array. And power supplying for the fan 3 can also be led in via an adapter 85, and the functions of voltage transforming, power switching as well as indicating can be performed by means of a power inverter 86 (as shown in FIG. 4).

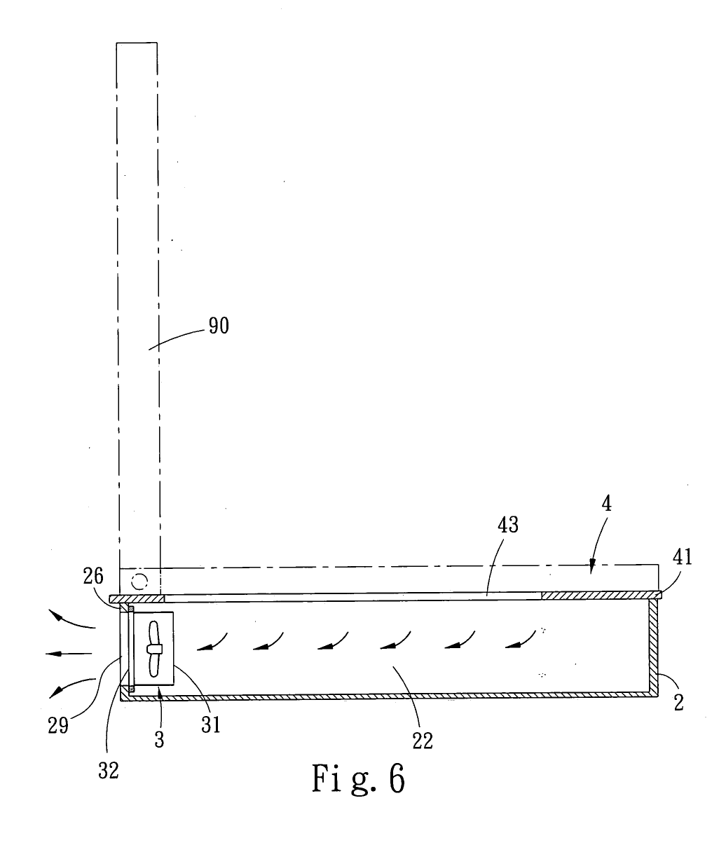

Referring to FIGS. 5 and 6, when the notebook computer 90 is placed on the upper lid 4, heat generated by long-time using of the notebook computer 90 can be led into the receiving space 22 of the base 2 through the upper panel 41 of the upper lid 4 and through the air-venting hole 43 on the upper panel 41. When the power switch 82 is activated to run the fan 3, heat in the receiving space 22 gets through the air-drawing end 31 of the fan 3 and is dissipated via the air-dissipating end 32 of the fan 3 and the heat-sinking hole 29 on the rear side plate 26 of the base 2. Thus temperature can be lowered, and the notebook computer 90 will not generate high temperature; rather, it can have a normal working temperature in a long-time operation.

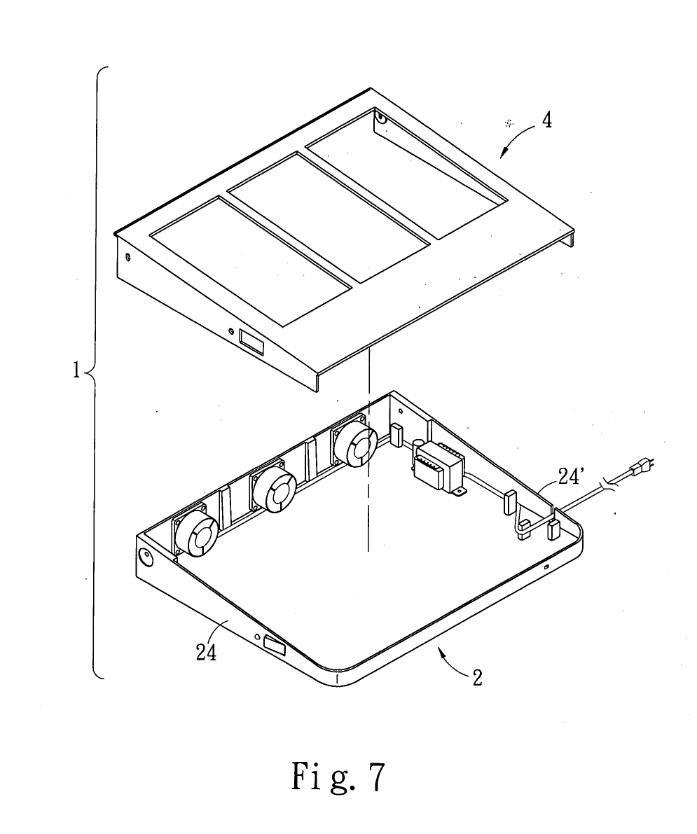

Referring to FIG. 7 showing a second embodiment of the auxiliary cooling device 1 for a notebook computer 90 of the present invention, the two lateral side plates 24, 24′ of the base 2 are inclined from their rear ends to their front ends with same inclining angle. When the upper lid 4 covers the upper end of the base 2, the upper lid 4 slopes forwardly; so that when the notebook computer 90 is placed on the upper lid 4, the front end of the notebook computer 90 will not hinder the working hands because of being overly high, and this is benefit to operation of the notebook computer 90.

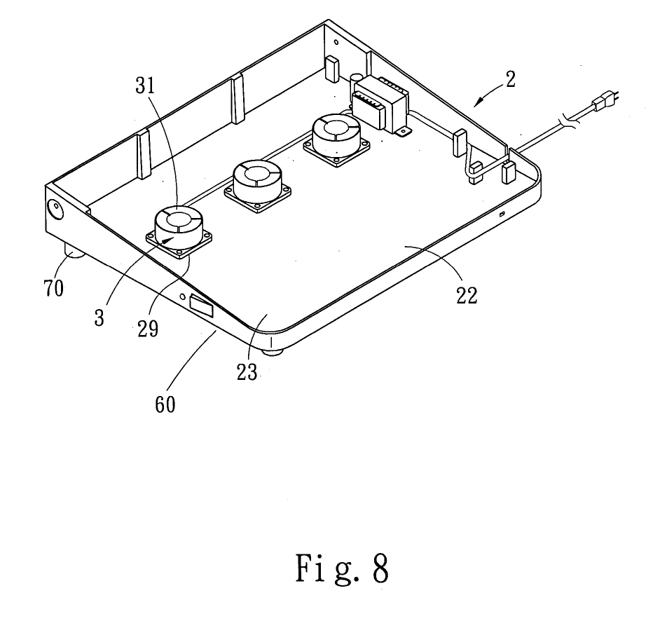

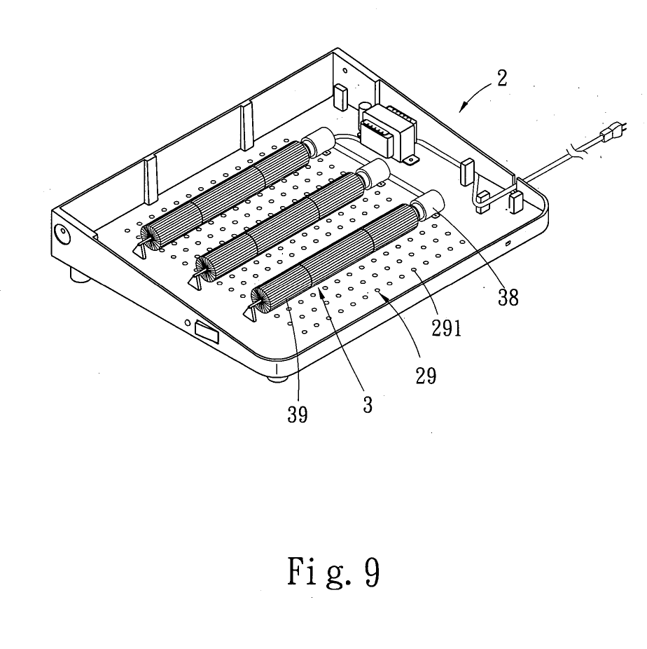

Referring to FIG. 8, to make the thickness of the present invention thinner for the convenience of carrying, the heat-sinking holes 29 in the above stated first and second embodiments can also be provided respectively on the bottom plate 23 of the base 2 of their own, hence the original upright fans 3 occupying larger space can be laid flat and clung onto the heat-sinking holes 29 and are locked onto the bottom plate 23 to lower their heights. The base 2 is provided beneath the four corners thereof with supporting feet 70 to support the base 2, so that the base 2 is formed thereunder a heat-sinking space 60. When the fan 3 is rotated, heat in receiving space 22 gets through the air-drawing end 31 of the fan 3 and is dissipated via the air-dissipating end 32 (not shown) of the fan 3 and the heat-sinking hole 29 on the rear side plate 26 of the base 2, thus the effect of heat sinking is obtained. And the fan 3 can also comprise a motor 38 and a cylindrical air-dissipating vane wheel 39, while the heat-sinking hole 29 comprises an array of holes 291 (as shown in FIG. 9).

With the above stated assembly, the present invention has the following advantages:
1. When the present invention is placed beneath the notebook computer, heat generated by operating the notebook can be led into the receiving space of the base through the upper panel of the upper lid and the air-venting hole on the upper panel. The heat is dissipated when the fan runs. Thus temperature of the notebook computer can be effectively lowered, and the notebook can afford a long-time operation.
2. The base of the present invention inclines from its rear end to its front end, when the upper lid covers the upper end of the base and when the notebook computer is placed on the upper lid, the notebook computer is also inclined frontwards, this will be beneficial to operation of the key board of the notebook computer and not hinder the working hands because of being overly high.

In conclusion, according to the above statement, the present invention surely can acquire its expected object to provide an auxiliary cooling device for a notebook which can make the notebook lower temperature to maintain its norm working temperature; this can afford long-time operation of the notebook. Having thus described my invention, what I claim as new, industrially practicable and desire to be secured by Letters Patent of the United States are:

1. An auxiliary cooling device for a notebook computer, said device is for placing beneath said notebook computer and is comprised of:
a base being a box with an opening on an upper side thereof, and forming a receiving space therein, said base has at least one heat-sinking hole in communication with outside;
an upper lid covering said upper side of said base, said upper lid has on an upper panel thereof an air-venting hole; and
at least a fan mounted in said base, an air-drawing end of said fan is located in said receiving space of said base, while an air-dissipating end of said fan is communicated with outside said base via said heat-sinking hole;
thereby, when said notebook computer is placed on said upper lid, heat generated by operating said notebook computer is led into said receiving space of said base, thus temperature of said notebook computer is lowered to afford long-time operation of said notebook computer.

2. The auxiliary cooling device for a notebook computer as in claim 1, wherein said base is composed of a bottom plate and four upright peripheral side plates extending upwardly from said bottom plate; two lateral ones of said side plates of said base are provided on both rear ends thereof with a pivot hole; two side plates of said upper lid are provided on both rear ends thereof with a pivot connecting-axle extending inwardly for pivot connecting with said base.

3. The auxiliary cooling device for a notebook computer as in claim 2, wherein said upright peripheral side plates are equal by height.

4. The auxiliary cooling device for a notebook computer as in claim 2, wherein said two lateral ones of said side plates of said base are inclined from their rear ends to their front ends, when said upper lid covers said base, said notebook computer is adapted for laying flat with a tilting angle.

5. The auxiliary cooling device for a notebook computer as in claim 1, wherein said heat-sinking hole is provided on a rear one of side plates of said base, said fan is clung onto said heat-sinking hole for being locked upright.

6. The auxiliary cooling device for a notebook computer as in claim 1, wherein said heat-sinking hole is provided on a bottom plate of said base, said fan is laid flat and locked; said base is provided therebeneath with a plurality of supporting feet, when said fan is rotated, heat is dissipated downwardly via said air-dissipated end.

7. The auxiliary cooling device for a notebook computer as in claim 6, wherein said fan comprises a motor and a cylindrical air-dissipating vane wheel.

8. The auxiliary cooling device for a notebook computer as in claim 1, wherein said air-venting hole on said upper panel of said upper lid comprises a plurality of rectangular holes.

9. The auxiliary cooling device for a notebook computer as in claim 1, wherein said air-venting hole on said upper panel of said upper lid includes a lot of holes arranged in an array.

10. The auxiliary cooling device for a notebook computer as in claim 1, wherein said base is provided externally thereof with an electric plug for connecting to a power supply, and is provided therein with a transformer in connection with said fan; said two lateral ones of said side plates of said base are provided with a power switch and an indication lamp.
